(19) United States
(12) Patent Application Publication
(10) Pub. No.: US 2015/0122091 A1
(43) Pub. Date: May 7, 2015

(54) TYPE ADJUSTABLE TORQUE WRENCH AND THE USE METHOD THEREOF

(71) Applicant: ZHONGSHAN OBO PACKAGING MATERIAL PRODUCTS CO., LTD., Zhongshan (CN)

(72) Inventor: Changchun Chen, Zhongshan (CN)

(73) Assignee: ZHONGSHAN OBO PACKAGING MATERIAL PRODUCTS CO., LTD., ZHONGSHAN (CN)

(21) Appl. No.: 14/137,946

(22) Filed: Dec. 20, 2013

(30) Foreign Application Priority Data
Nov. 1, 2013 (CN) CN201320682165.2

(51) Int. Cl. B25B 23/142; B25B 23/14; B25B 15/02

(52) U.S. Cl. CPC B25B 23/1427; B25B 15/02; B25B 23/141
USPC 81/475

(57) ABSTRACT

A new type adjustable torque wrench is disclosed, which comprises a handle, a housing and a screwdriver, wherein the housing is engaged with handle, a cylindrical barrel is fixed into the housing, a lower and upper gear arranged in the barrel, and the engagement surfaces therebetween consist of a number of circumferentially arranged inclined surfaces, the upper gear contains several clamping strips on the outer side wall for engagement with the corresponding gear grooves on the inner wall of the barrel, the barrel has several notches regularly spaced on the upper circumferential surface, a rotatable lid containing several protrusions on the side wall for engagement with the notches is arranged on the notches, a spring and a gasket are provided between the rotatable lid and the upper gear, there is a locking apparatus disposed on the rotatable lid.

### TECHNICAL FIELD

The present application relates to the technical field of mechanical tool, in particular, to a new type adjustable torque wrench.

### BACKGROUND

The existing wrenches typically have fixed torque force, the torque force thereof are nonadjustable, they are often employed for tightening operation directly where a tightening is needed. In this case, the male threads may be destroyed under too much force, which causes irreversible damage and brings many inconveniences to the user.

### SUMMARY

### (1) Technical Problem

A technical problem solved by this application is to provide a new type adjustable torque wrench, wherein the torque force thereof may be adjusted easily by changing the thickness of the gasket.

### (2) Technical Solution

The above-mentioned technical problems can be solved through the following technical solutions:

A new type adjustable torque wrench comprising a handle, a housing and a screwdriver, wherein one end of the screwdriver is located below the handle, the other end thereof extends out of the lower end surface of the housing, the upper end of the housing is engaged with the lower edge of the handle, the handle and the housing fix to each other, a cylindrical barrel is fixed into the housing, a lower gear and an upper gear disposed above the lower gear and meshed therewith are arranged in the barrel, the engagement surfaces of the lower gear and upper gears consist of a number of circumferentially arranged inclined surfaces respectively, the upper gear contains several clamping strips disposed on the outer side wall for engagement with the corresponding gear grooves on the inner wall of the barrel, the barrel has a number of notches regularly spaced on the circumferential surface, a rotatable lid containing several protrusions on the side wall for engagement with the notches is arranged on the notches, a spring and a gasket located on the spring are provided between the rotatable lid and the upper gear, a locking apparatus is disposed above the rotatable lid, wherein the locking apparatus has several protrusions on the side wall suitable for engagement with the grooves on the inner wall of the housing, and the screwdriver extends through the locking apparatus, rotatable lid, gasket, spring, and the upper and lower gears sequentially, the screwdriver fixes into the inner aperture of the lower gear, the rotatable lid has a rotary hole, wherein a pneumatic tool may drive the rotatable lid by inserting into the rotary hole to complete the process of the notches engaging with the protrusions.

The screwdriver has an annular groove at a middle portion of the length, thereby a C-shaped snap ring is engaged with the annular groove, thereby the screwdriver 3 fixes into the inner aperture of the locking apparatus, so the screwdriver and the locking apparatus may rotate co-axially.

The middle portion of the screwdriver has a cross section of regular hexagon, the inner aperture of the lower gear has a corresponding regular hexagon matching with the cross section of the screwdriver.

### (1) Advantageous Effects

Compared with the prior arts, the torque wrench of this application has the following beneficial effects: the torque force required is adjusted by means of the meshing of the upper gear and the lower gear and the preload of the spring, as well as the adjustment of the gasket thickness, so as to achieve a fast and accurate adjustment.

### BRIEF DESCRIPTION OF THE DRAWINGS

FIG. 1 is an exploded view of the new type adjustable torque wrench of this application.

FIG. 2 is another exploded view of the new type adjustable torque wrench of this application.

FIG. 3 is a sectional view of the new type adjustable torque wrench of this application.

FIG. 4 is a perspective view of the barrel of the new type adjustable torque wrench of this application.

### DETAILED DESCRIPTION OF THE INVENTION

The present application will be explained below in detail with reference to the accompanying drawings and the embodiments. However, it is to be appreciated that the following description of the embodiments is merely exemplary in nature and is no way intended to limit the application.

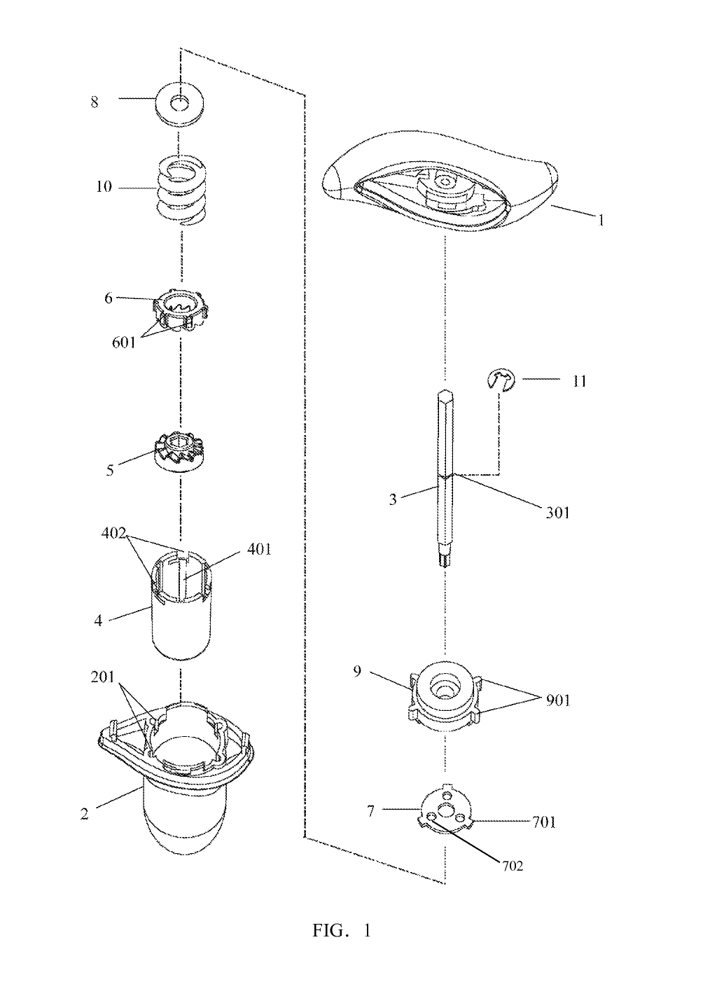

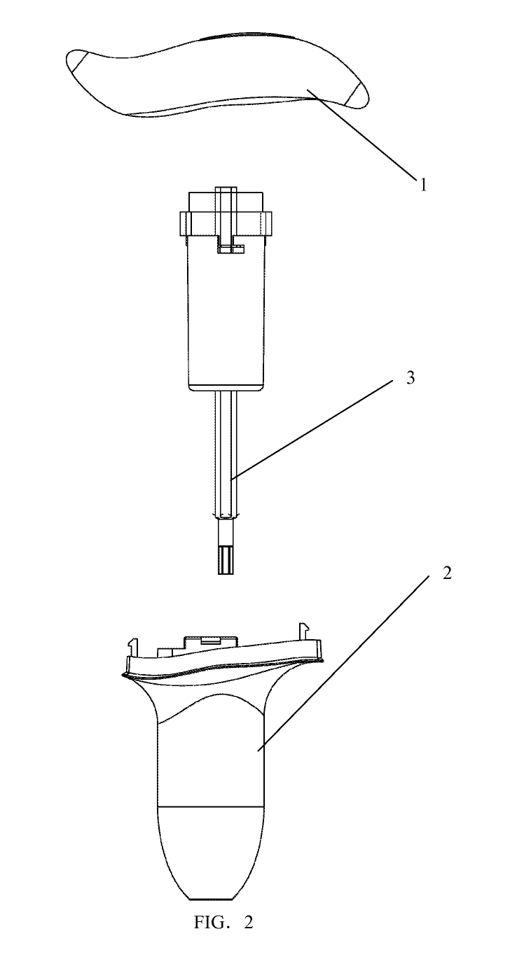

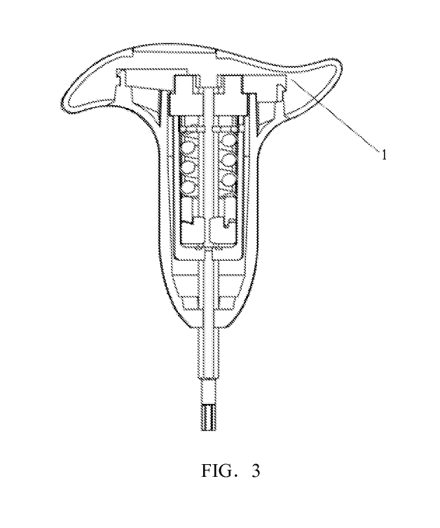

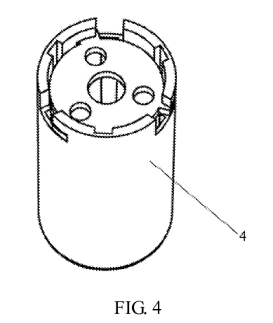

As shown in FIGS. 1 to 4, a new type adjustable torque wrench is provided, which comprises a handle 1, a housing 2 and a screwdriver 3, wherein one end of the screwdriver 3 is located below the handle 1, the other end extends out of the lower end surface of the housing 2, the housing 2 is engaged with the lower edge of the handle 1 at the upper end, and the handle 1 and the housing 2 are fixed to each other, a cylindrical barrel 4 is fixed into the housing 2, a lower gear 5 and an upper gear 6 disposed over the lower gear and meshed therewith are arranged in the barrel 4, the engagement surfaces of the lower gear 5 and upper gear 6 consist of a number of circumferentially arranged inclined surfaces respectively, the upper gear 6 contains several clamping strips 601 disposed on the outer side wall for engagement with the corresponding gear grooves 401 on the inner wall of the barrel 4, the barrel 4 has a number of notches 402 regularly spaced on the circumferential surface, a rotatable lid 7 containing several protrusions 701 on the side wall for engagement with the notches is arranged on the notches 402, a spring 10 and a gasket 8 located on the spring 10 are provided between the rotatable lid 7 and the upper gear 6, a locking apparatus 9 having several protrusions 901 on the side wall is disposed above the rotatable lid 7, wherein the protrusions 901 are suitable for engagement with the grooves 201 on the inner wall of the housing 2, and the screwdriver 3 extends sequentially through the locking apparatus 9, rotatable lid 7, gasket 8, spring 10, the upper gear 6 and the lower gear 5, and the screwdriver 3 is fixed into the inner aperture of the lower gear 5. The rotatable lid 7 has a rotary hole 702, wherein a pneumatic tool may drive the rotatable lid by inserting into the rotary hole 702 to make the notches 402 engage with the protrusions 701.

A middle portion of the screwdriver 3 has an annular groove 301 thereon, and a C-shaped snap ring 11 is engaged with the annular groove 301 thereby the screwdriver 3 fixes into the inner aperture of the locking apparatus 9, thus, the screwdriver 3 and the locking apparatus 9 may rotate coaxially.

The middle portion of the screwdriver 3 has a cross section of regular hexagon, and the inner aperture of the lower gear 5 has a regular hexagon matching with the screwdriver 3.

The gasket has the thickness of 0.5 mm, 1 mm, 1.5 mm, 2 mm, and the like, and different thicknesses of the gasket are used for adjusting the torque value.

The spring provides a certain preload force to the upper and lower gears and makes them pressed, because of the inclined surface meshing of the upper and lower gears, when the torque moment acting on the lower gear is bigger than the meshing force, there will he a relative sliding between the upper and lower gears.

A method for employing the new type adjustable torque wrench of this application, comprising:

tightening the element to be tightened by means of the head of the screwdriver;

continuously tightening until there is no loosening appears, that is the end of the operation; if there is relative sliding between the upper gear and the lower gear in the wrench when the tightening is operated, the element cannot be tightened furthermore;

removing the locking apparatus and the rotatable lid, and replacing the gasket with another one of appropriate thickness, then re-fitting the locking apparatus and the rotatable lid on the wrench and tightening again, then repeating step (2);

both the barrel and the locking apparatus being put into the housing when assembling the wrench.

It should be acknowledged that the embodiments disclosed in this application are to be considered in all respects as illustrative and not limitative. The present application may he embodied in other forms without departing from the spirit of this application. All changes which come within the meaning and range of equivalency of the claims are intended to be embraced therein.

What is claimed is:

1. An adjustable torque wrench, comprising a handle, a housing and a screwdriver, wherein one end of the screwdriver is located below the handle, the other end thereof extends out of the lower end surface of the housing, the upper end of the housing is engaged with the lower edge of the handle, wherein the handle and the housing are fixed to each other, a cylindrical barrel is fixed into the housing, a lower gear and an upper gear disposed above the lower gear and meshed therewith are arranged in the barrel, the engagement surfaces of the lower and upper gears consist of a number of circumferentially arranged inclined surfaces respectively, the upper gear contains several clamping strips disposed on the outer side wall for engagement with the corresponding gear grooves on the inner wall of the barrel, the barrel has a number of notches regularly spaced on the circumferential surface, a rotatable lid containing several protrusions on the side wall for engagement with the notches is arranged on the notches, a spring and a gasket located on the spring are provided between the rotatable lid and the upper gear, a locking apparatus is disposed above the rotatable lid, and the locking apparatus has several protrusions on the side wall suitable for engagement with the grooves on the inner wall of the housing, and the screwdriver extends sequentially through the locking apparatus, rotatable lid, gasket, spring, and the upper and lower gears, the screwdriver fixes into the inner aperture of the lower gear, the rotatable lid has a rotary hole, wherein a pneumatic tool is able to drive the rotatable lid by inserting into the rotary hole to make the notches engage with the protrusions.

2. The adjustable torque wrench of claim 1, wherein a middle portion of the screwdriver has an annular groove, and a C-shaped snap ring is engaged with the annular groove thereby the screwdriver fixes into the inner aperture of the locking apparatus, thus the screwdriver and the locking apparatus rotate coaxially.

3. The adjustable torque wrench of claim 1, wherein the middle portion of the screwdriver has a cross section of regular hexagon, and the inner aperture of the lower gear has a regular hexagon matching with the cross section of the screwdriver.
